(19) United States
(12) Patent Application Publication
(10) Pub. No.: US 2023/0140275 A1
(43) Pub. Date: May 4, 2023

(54) METHOD FOR DISPLAYING STATE INFORMATION, DEVICE AND STORAGE MEDIUM

(71) Applicant: BEIJING DAJIA INTERNET INFORMATION TECHNOLOGY CO., LTD., Beijing (CN)

(72) Inventors: Hanyao SHAO, Beijing (CN); Min ZHANG, Beijing (CN); Chenyang LI, Beijing (CN); Xuangang FENG, Beijing (CN); Wenxuan HE, Beijing (CN); Rongyang SHAN, Beijing (CN)

(21) Appl. No.: 17/875,636

(22) Filed: Jul. 28, 2022

(30) Foreign Application Priority Data
Oct. 29, 2021 (CN) 202111275867.4

(51) Int. Cl. G06Q 10/10; G06F 40/166

(52) U.S. Cl. CPC G06Q 10/1095; G06F 40/166

(57) ABSTRACT

A method for displaying state information is performed by a first terminal logged with a first user account. The method includes monitoring a service event in a target application associated with a first user account, and in response that the service event is monitored, displaying service state information corresponding to the service event in a first preset area of a first page of a first terminal.

### CROSS REFERENCE TO RELATED APPLICATIONS

This application is based on and claim priority to Chinese Patent Application No. 202111275867.4, filed on Oct. 29, 2021, the content of which is incorporated herein by reference in its entirety.

### TECHNICAL FIELD

The disclosure relates to the field of Internet technology, and more particularly to a method and an apparatus for displaying state information, a device and a storage medium.

### BACKGROUND

Personal homepage is a service provided by some portal websites to a user. The user may make his/her own homepage and upload it to these websites, and freely publish information on his/her own personal homepage.

### SUMMARY

According to a first aspect of the disclosure, there is provided a method for displaying state information The method is performed by a first terminal logged with a first user account. The method includes monitoring a service event in a target application associated with the first user account, and in response that the service event is monitored, displaying service state information corresponding to the service event in a first preset area of a first page of the first terminal.

According to a second aspect of the embodiments of the disclosure, an electronic device is provided, which includes a processor, and a memory for storing instructions executable by the processor. The processor is configured to execute the instructions to implement the method for displaying state information. The method includes monitoring a service event in a target application associated with the first user account, and in response that the service event is monitored, displaying service state information corresponding to the service event in a first preset area of a first page of the first terminal.

According to a third aspect of the embodiments of the disclosure, there is provided a non-transitory computer readable storage medium, when instructions in the computer readable storage medium are executed by a processor of an electronic device, the electronic device is caused to execute the method for displaying state information. The method includes monitoring a service event in a target application associated with the first user account, and in response that the service event is monitored, displaying service state information corresponding to the service event in a first preset area of a first page of the first terminal.

It should be understood that the above general description and the following detailed description are exemplary and explanatory, without any limitations to the disclosure.

### BRIEF DESCRIPTION OF THE DRAWINGS

The drawings herein are incorporated into the specification and constitute a part of the specification, show embodiments in accordance with the disclosure, and are used to explain the principle of the disclosure together with the specification, which do not constitute an improper limitation to the disclosure.

FIG. 1 illustrates an application environment diagram of a method for displaying state information according to an embodiment.

FIG. 2 illustrates a flowchart of a method for displaying state information according to an embodiment.

FIG. 3 illustrates a flowchart of displaying parse information according to an embodiment.

FIG. 4 illustrates a schematic diagram of a personal homepage for a user account according to an embodiment.

FIG. 5 illustrates a schematic diagram of a setting page according to an embodiment.

FIG. 6 illustrates a schematic diagram of a state editing page according to an embodiment.

FIG. 7 illustrates a schematic diagram of receiving an information resource link in a text editing area and displaying parse information corresponding to the information resource link according to an embodiment.

FIG. 8 illustrates a schematic diagram of a page for selecting expression state information according to an embodiment.

FIG. 9 illustrates a flowchart of displaying updated state information according to an embodiment.

FIG. 10 illustrates a flowchart of displaying added state information according to an embodiment.

FIG. 11 illustrates a schematic diagram of adding service state information to a header of text editing information according to an embodiment.

FIG. 12 illustrates a flowchart of displaying state recommendation information according to an embodiment.

FIG. 13 illustrates a schematic diagram of another personal homepage for a user account according to an embodiment.

FIG. 14 illustrates a schematic diagram of a session page according to an embodiment.

FIG. 15 illustrates a schematic diagram of a user account list page according to an embodiment.

FIG. 16 illustrates a schematic diagram of a user account prompt page in an information interaction group according to an embodiment.

FIG. 17 illustrates a schematic diagram of a user account search page according to an embodiment.

FIG. 18 illustrates a schematic diagram of a user account selection page according to an embodiment.

FIG. 19 illustrates a schematic diagram of a message aggregator according to an embodiment.

FIG. 20 illustrates a schematic diagram of clicking service state information and displaying duration according to an embodiment.

FIG. 21 illustrates a schematic diagram of a second information interaction page according to an embodiment.

FIG. 22 illustrates a block diagram of an apparatus for displaying state information according to an embodiment.

FIG. 23 illustrates a block diagram of an electronic device for displaying state information according to an embodiment.

### DETAILED DESCRIPTION

In order to make those skilled in the art better understand the technical solutions of the disclosure, the technical solutions in the embodiments of the disclosure may be clearly and thoroughly described with reference to the accompanying drawings.

The relevant information of user accounts (including social relationship identity information and the like) described in the embodiments of the disclosure are obtained under user permission. On the premise of obtaining user permission and authorization, the method, apparatus, device and storage medium involved in the disclosure can obtain the relevant information of users.

It should be noted that the terms such as “first” and “second” in the specification, claims and the drawings of the disclosure are used to distinguish similar objects, and not necessarily used to describe a specific sequence or precedence order. It should be understood that the data used in this way may be interchanged under appropriate circumstances so that the embodiments of the disclosure described herein may be implemented in an order other than those illustrated or described herein. The implementations described in the embodiments below do not represent all implementations consistent with the disclosure. Rather, they are merely examples of apparatuses and methods consistent with some aspects of the disclosure as detailed in the appended claims.

In the related art, a personal signature is usually displayed on the personal homepage by a user to a relevant contact, so that the relevant contact may learn about personal state information of the user through the personal signature. However in the related art, the state edited by the user needs to be displayed in response to a state editing instruction from the user. The state edited manually by the user may not be linked with a user service in real time, resulting in poor timeliness in displaying service state information associated with the user service.

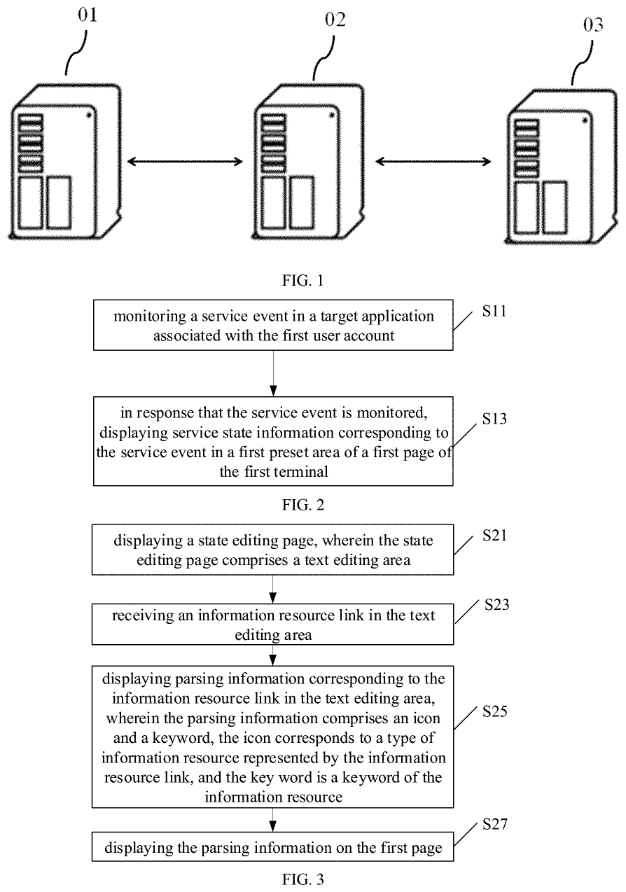

Referring to FIG. 1, it is an application environment diagram of a method for displaying state information according to an embodiment. The application environment may include a first terminal 01, a server 02 and a second terminal 03. The server 02 may communicate with the first terminal 01 and the second terminal 03 in in a wired or wireless manner, which is not limited in the disclosure.

In particular, a personal homepage of the first user account may be created on the server 02 for use through the target application in the first terminal 01. The second user account that has a social relationship with the first user account may log in to the server through the target application in the second terminal 03 to browse the personal homepage created by the first user account.

In an example, the target application is an application (APP) including a personal homepage of a user account, for example, social software/APP, instant messaging software, short video software, audio and video conferencing software, project management software, document software, etc.

In an example, the social relationship may include a friend relationship embodied in the instant messaging, social software, and the like.

The first terminal 01 may be configured to monitor in real time a service event associated with the first user account in the target application; and display service state information corresponding to the service event in a first preset area of a first page of the first terminal.

The server 02 may be a server corresponding to the target application, and may be configured to receive the service state information sent by the first terminal 01 and forward the service state information to the second terminal 03. In an example, the server 02 may be an independent physical server, a server cluster or a distributed system composed of multiple physical servers, or a cloud server which provides basic cloud computing services, such as, a cloud service, a cloud database, cloud computing, cloud function, cloud storage, network services, cloud communications, middleware services, domain name services, security services, a content delivery network (CDN), big data and artificial intelligence platforms, and so on.

The second terminal 03 may be configured to receive the service state information sent by the server 02, and display the service state information on a corresponding page.

In an example, the first terminal 01 and the second terminal 03 may include but are not limited to, smart phones, desktop computers, tablet computers, laptop computers, digital assistants, augmented reality (AR)/virtual reality (VR)) devices, smart wearable devices and other terminal devices.

In addition, it should be noted that, what is shown in FIG. 1 is an application environment diagram of displaying state information in the disclosure, and other application environments may also be included in practical applications.

FIG. 2 is a flow chart of a method for displaying state information according to an embodiment. As shown in FIG. 2, the method for displaying state information may be applied to a first terminal (i.e., the first terminal 01 in FIG. 1) logged with a first user account, and may include the following steps at S11-S13.

At S11, a service event associated with the first user account in the target is monitored.

At S13, in response that the service event is monitored, service state information corresponding to the service event is displayed in a first preset area of a first page of the first terminal.

In an example, the service event may include but are not limited to, a business trip approval event, a vacation approval event, an event for initiating or accepting a meeting schedule, and the like.

In an example, a preset mapping relationship between service events and pieces of service state information may be pre-stored in the first terminal, and when a service event is monitored, the first terminal acquires service state information corresponding to the service event and displays the service state information in the first preset area.

In an example, the service state information may include, but is not limited to, a business trip state corresponding to the business trip approval event, a vacation state corresponding to the vacation approval event, a meeting state corresponding to the event for initiating or accepting a meeting schedule, and the like.

In an example, the event for initiating or accepting a meeting schedule includes an event for initiating a meeting schedule or an event for accepting a meeting schedule. The event for initiating a meeting schedule may be a meeting schedule established by the first user account. The event for accepting a meeting schedule may include but are not limited to, a meeting schedule is shared by other user accounts (i.e., the first user account joins in the meeting by default, in other words, other user accounts directly pull the first user account into the meeting), a meeting is established by other user accounts and the first user account belongs to a participant of the meeting, a meeting shared by other user accounts is received (that is, other user accounts send a meeting schedule to the first user account, and the first user account receives the meeting schedule and joins in the meeting schedule when the first user account needs to join it).

In an optional embodiment, the service event includes at least one of: a business trip approval event, a vacation approval event and an event for initiating or accepting a meeting schedule; and the service state information includes at least one of: a business trip state corresponding to the business trip approval event, a vacation state corresponding to the vacation approval event, and a meeting state corresponding to the event for initiating or accepting a meeting schedule. Then, the above step at S13 of in response that the service event is monitored, displaying service state information corresponding to the service event in a first preset area of a first page of the first terminal may include:

in response that the business trip approval event is monitored, displaying the business trip state in the first preset area; and/or

in response that the vacation approval event is monitored, displaying the vacation state in the first preset area; and/or

in response that the event for initiating or accepting a meeting schedule is monitored, displaying the meeting state in the first preset area.

In an example, in response that one of the service events (for example, the business trip approval event, the vacation approval event and the event for initiating or accepting a meeting schedule, the service state information (for example, the business trip state, or the vacation state, or the meeting state) corresponding to one of the service events may be displayed in the first preset area of the first page.

In an example, since there may be a plurality of service events, at least two service events may be monitored at the same time (for example, the business trip approval event and the meeting schedule event are monitored at the same time, or the vacation approval event and the meeting schedule event are monitored at the same time), a priority of each service event may be preset. When at least two service events are monitored at the same time, the service state information corresponding to the service event with a higher priority is displayed in front of the service state information corresponding to the service event with a lower priority. For example, when the priority of the business trip approval event is higher than that of the meeting schedule event, and when the business trip approval event and the meeting schedule event are monitored at the same time, both the business trip state and the meeting state may be displayed on the first page at the same time and the business trip state may be displayed in front of the meeting state.

In an example, when multiple business states are displayed on the first page, it may result in more content displayed on the first page and degrade user experience. In order to avoid this problem, when at least two service events are monitored at the same time, pieces of service state information corresponding to service events with high priority may also be displayed on the first page. For example, when the priority of the business trip approval event is higher than that of the meeting schedule event, only the business trip state may be displayed on the first page when both the business trip approval event and the meeting schedule event are monitored at the same time.

In the embodiments of the disclosure, when one or more of the business trip approval event, the vacation approval event, and the meeting schedule event are monitored, one or more of the business trip state, vacation state and meeting state are displayed in a preset area on the first page in time, so that the corresponding service state information is synchronously displayed to the first user account, and the display of service state information may be linked with the user service in real time. As such, the timeliness of displaying service state information is improved, it is helpful for the first user account to learn current service state information in time, and user experience is thus improved.

In an embodiment, in response that the event for initiating or accepting a meeting schedule is monitored, the method further includes:

in response that the business trip state and/or the vacation state is displayed in the first preset area, continuing to display the business trip state and/or the vacation state in the first preset area; and

in response that the business trip state and/or the vacation state is not displayed in the first preset area, displaying the meeting state in the first preset area.

In the embodiment of the disclosure, when the first user account is on a business trip or on leave, there may still be a need to participate in a meeting. When the event for initiating or accepting a meeting schedule is monitored at the current time, displaying the business trip state and/or the vacation state in the first preset area is continued when the business trip state and/or the vacation state has been displayed on the first page at the current time. When the business trip state and/or the vacation state has not been displayed on the first page at the current time, the meeting state is displayed on the first page, so that the displayed service state information is closer to a current state of the first user account, thus improving the flexibility of state presentation and user experience.

In an embodiment, in response that the event for initiating or accepting a meeting schedule is monitored, displaying the meeting state in the first preset area may include:

in response to the meeting schedule event being a preset schedule event, displaying service state information corresponding to the preset schedule event in the first preset area; and

in response to the meeting schedule event being an event other than the preset schedule event, displaying the meeting state in the first preset area.

In an example, the preset schedule event may be a leave schedule event, a business trip schedule event, or the like.

In an example, when the first terminal identifies that there are keywords such as asking for leave or business trip in a meeting theme, and determines that the meeting schedule event is a preset schedule event, service state information corresponding to the preset schedule event may be displayed in the first preset area. For example, when the preset schedule event is a leave schedule event, the corresponding service state information is a vacation state. When the preset schedule event is a business trip schedule event, the corresponding service state information is a business trip state. When the first terminal identifies that there are no keywords such as asking for leave or business trip identified in the meeting theme, and determines that the meeting schedule event is an event other than the preset schedule event, the meeting state may be displayed in the first preset area, so that the displayed service state information is closer to a current state of the first user account, thus improving the flexibility of state display and user experience.

FIG. 3 illustrates a flowchart of displaying parse information according to an embodiment. As shown in FIG. 3, in an optional embodiment, the method may further include the steps at S21-S27.

At S21, a state editing page is displayed. The state editing page includes a text editing area.

At S23, an information resource link is received in the text editing area.

At S25, parse information corresponding to the information resource link is displayed in the text editing area. The parse information includes an icon and a keyword, the icon corresponds to a type of information resource represented by the information resource link, and the keyword is a keyword of the information resource.

At S27, the parse information is displayed on the first page.

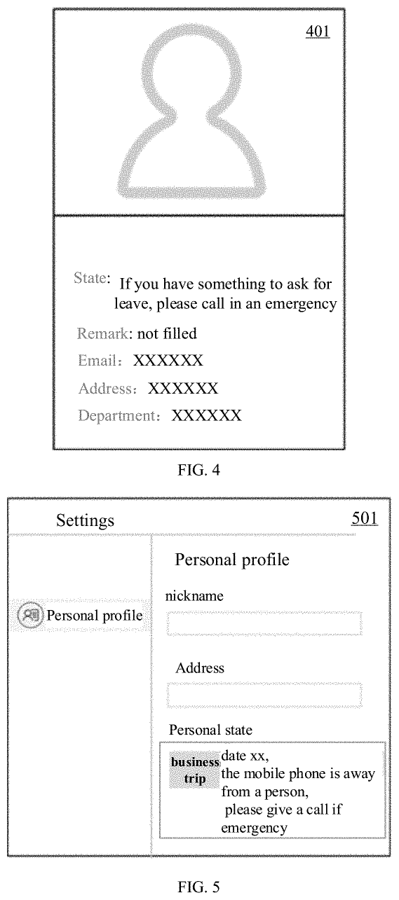

FIG. 4 illustrates a schematic diagram of a personal homepage 401 of a user account according to an embodiment. FIG. 5 illustrates a schematic diagram of a setting page 501 according to an embodiment. The first user account may enter the setting page 501 (shown in FIG. 5) through the personal homepage (shown in FIG. 4).

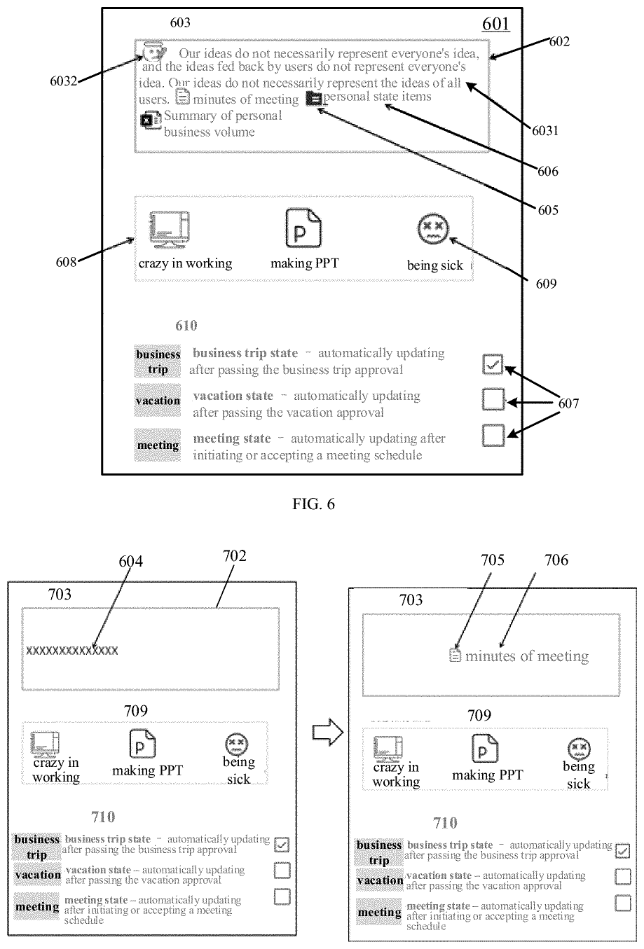

FIG. 6 illustrates a schematic diagram of a state editing page 601 according to an embodiment. In an example, the first user account may trigger an instruction for edit page display by clicking an editing box corresponding to the personal state in FIG. 5. The first terminal displays a state editing page 601 as shown in FIG. 6 in response to the instruction for edit page display.

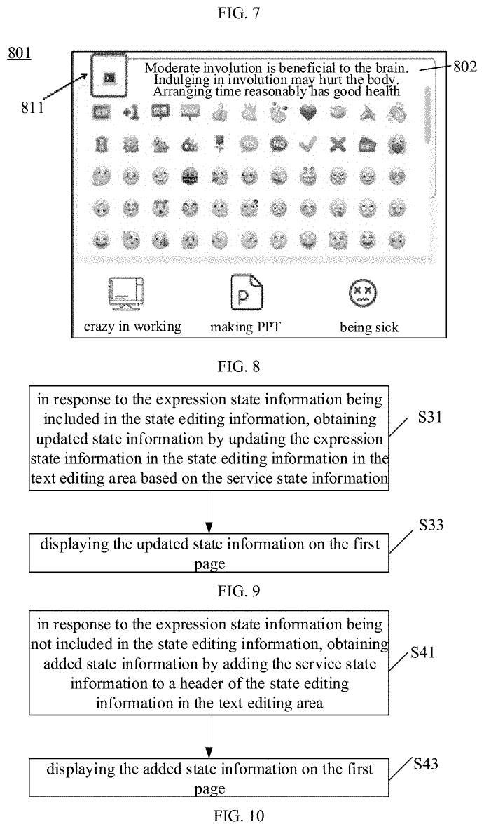

In an example, the state editing page 601 may include a text editing area 602. The first user account may customize state editing information 603 in the text editing area 602, and the state editing information 603 may include an information resource link 604 (as shown in FIG. 7, which may be a document link for example).

Specifically, the parse information is used to point to the information resource, that is, the first user account clicks the parse information, and the first terminal may jump to information resource corresponding to the information resource link 604. In an example, a type of information resource may include, but is not limited to, a document, a video, text, a table, a PPT, a team management file/page, contact information (e.g., phone numbers), and the like.

In an example, when the type of information resource is a document, and the first user account or a second user account that has a social relationship with the first user account clicks the parse information, the first terminal may jump to the document. When the resource type is phone and the first or the second user account clicks the parse information, the phone number may be dialed.

In an example, the first user account may trigger an input instruction for information resource link 604 by inputting an information resource link 604 in the text editing area 602. The first terminal responds to the input instruction for information resource link 604 and receives an information resource link 604 in the text editing area 602. After the first terminal receives the information resource link 604, the information resource link 604 may be parsed to obtain an icon 605 and a keyword 606 corresponding to the information resource link 604, and the parse information corresponding to the information resource link 604 is displayed in the text editing area 602 within a preset time (for example, 2 s, etc.). In some embodiments of the disclosure, the keyword 606 is used to represent the main content of information resource link 604, which enables a setter or acquirer of the state information to quickly obtain the key content of information resource link 604. The icon 605 is used to indicate a type of information resource represented by the information resource link 604, which enables the setter or acquirer of the state information to quickly understand the type of information resource link 604.

In an example, the keyword 606 includes page content pointed by the information resource link 604, which may include, but be not limited to, a title, an abstract, an article classification, a keyword tag, an author and the like of the page content.

For example, if the first user account inputs a link to a certain document in the text area, within a preset time of inputting the document link, the first terminal may automatically parse the corresponding document link in the text editing area 602 and display parse information (i.e. the icon and keywords of the document) corresponding to the document link. If the first user account inputs a link to an online table in the text area, within a preset time of inputting the online table link, the first terminal may automatically parse the corresponding online form link in the text editing area 602 and display parse information (i.e., the icon 605 and keywords 606 of the online table) corresponding to the online table link.

FIG. 7 illustrates a schematic diagram of receiving an information resource link 604 in a text editing area 702 and displaying parse information corresponding to the information resource link 604 according to an embodiment. As shown in FIG. 7, when the first user account inputs a certain document link 604 in the text editing area 702, the first terminal parses the document link 604, and displays an icon 705 and keywords 706 of the document in the text editing area 702 within a preset time.

In the embodiment of the disclosure, the first terminal may parse the information resource link 604 input by the first user account in the text editing area, obtain the corresponding icon and keywords, and display the icon and keywords corresponding to the information resource link 604 on the first page. Therefore, the type and keywords of information resource corresponding to the information resource link may be displayed visually in a succinct and clear manner to the first user account and/or other user accounts having a social relationship with the first user account, thus improving user experience. In addition, displaying the parse information on the first page may also enrich the expression form of state information of the first user account, which is helpful for the first user account and/or other user accounts to obtain in time various types of personal state information for the first user account and improves the richness of state information display and user experience.

In an embodiment, after the state editing page is displayed, the method may further include: receiving state editing information corresponding to the first user account in the text editing area, in which the state editing information includes text state information 6031 and/or expression state information 6032; and displaying the state editing information on the first page.

In an example, for text state information, the first user account may trigger an input instruction for text state information by inputting custom text in the text editing area. The first terminal responds to the input instruction for text state information and receives the text state information in the text editing area.

FIG. 8 illustrates a schematic diagram of a page 801 for selecting expression state information according to an embodiment. In an example, for expression state information, an icon or control 811 for expression selection may be preset in a text editing area 802, the first user account clicks the icon or control 811 for expression selection to trigger a display instruction for an expression selection page, and the first terminal responds to the display instruction for the expression selection page and displays the expression selection page shown in FIG. 8. The first user account may select the desired expression/expression from FIG. 8 to obtain the expression state information.

In an example, in order to improve user experience, when the state editing information includes expression state information and text state information, the expression state information may be displayed in front of the text state information.

In this embodiment of the disclosure, the first user account may customize and edit text state information and/or expression state information, and display the text state information and/or expression state information on the first page, thus enriching the expression form of the state information of the first user account, being helpful for the first user account and/or other user accounts to obtain various types of personal state information of the first user account in time, and improving the richness of state information display and user experience.

In an implementation, monitoring the service event associated with the first user account in the target application may include:

in response to a service state synchronization instruction, monitoring the service event, in which the service state synchronization instruction is triggered by the first user account based on the state editing page.

In an example, continuing as shown in FIG. 6, controls for enabling a synchronization state may be set on the state editing page, and when the first user account clicks the controls 607 for enabling a synchronization state, a service state synchronization instruction is triggered. In response to the service state synchronization instruction, the first terminal monitors the service events in real time. When the first user account does not click on the controls 607 for enabling a synchronization state, the service state synchronization instruction is not triggered and the service events are thus not monitored in real time, so that the service events may be monitored on demand and the flexibility of monitoring service events is improved.

Continuing as shown in FIG. 6, it should be noted that a corresponding control for enabling a synchronization state may be set for each service event. The service event whose control 607 for enabling a synchronization state is opened by the first user account, is monitored in real time, while the service event whose control 607 for enabling a synchronization state is not opened, is not monitored in real time. A control 607 for enabling a synchronization state may also be set for all service events. When the first user account clicks the control 607 for enabling a synchronization state, all service events may be monitored in real time.

FIG. 9 illustrates a flowchart of displaying updated state information according to an embodiment. As shown in FIG. 9, in an embodiment, the method may further include the steps at S31-S33.

At S31, when the state editing information includes the expression state information, the expression state information in the state editing information in the text editing area is updated based on the service state information to obtain updated state information.

At S33, the updated state information is displayed on the first page.

In an example, when the first user account has edited the expression state information in the text editing area, the edited expression state information may be replaced with the service state information corresponding to the monitored service event in response that the service event is monitored, to obtain the updated state information. The updated state information is displayed on the first page.

It should be noted that, in response that the expression state information in the text editing area is replaced with the service state information, the service state information may not be modified in the text editing area by the first user account. If the first user account wants to modify the service state information to the expression state information, the control for enabling a synchronization state in FIG. 6 needs to be off so as to disable the synchronization function of service state information. After the control 607 for enabling a synchronization state is disabled, the service state information is automatically updated to the expression state information before the replacement.

In the embodiment of the disclosure, by replacing the service state information corresponding to the monitored service events with the edited expression state information, not only it may be realized that the service state information is timely and synchronously displayed, but also interference of the expression state information may be avoided, so that the service state information is visually and clearly displayed to the first user account and/or other user accounts that have a social relationship with the first user account, the convenience to obtain service state information by the first user account and/or other user accounts is improved, and the user experience of the first user account and/or other user accounts is thus improved.

FIG. 10 illustrates a flowchart of displaying added state information according to an embodiment. As shown in FIG. 10, in an embodiment, the method may further include the steps at S41-S43.

At S41, when the state editing information does not include the expression state information, the service state information is added to a header of the state editing information in the text editing area to obtain added state information.

At S43, the added state information is displayed on the first page.

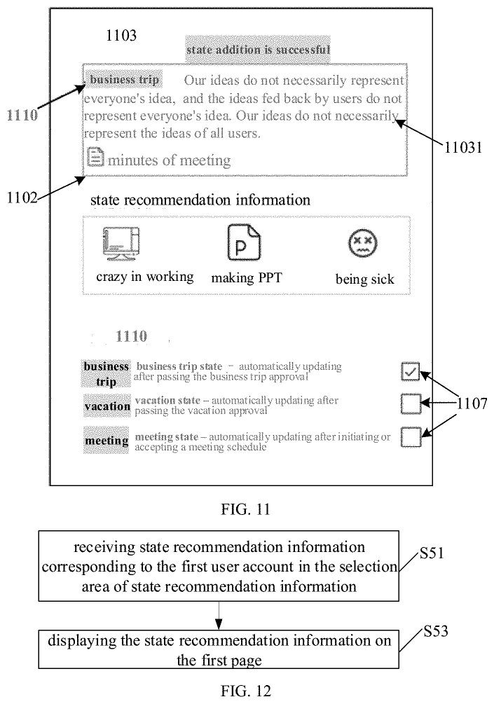

FIG. 11 illustrates a schematic diagram of adding service state information 1110 to a header of text editing information according to an embodiment. In an example, when the first user account has edited text state information and/or an information resource link in a text editing area, but has not edited expression state information, in response that a service event is monitored, service state information 1110 corresponding to the monitored service event may be added in front of the edited text state information 1110 and/or parse information corresponding to the information resource link, to obtain the added state information as shown in FIG. 11.

It should be noted that when the service state information 1110 is added to the header of text state information 11031 and/or parse information corresponding to the information resource link in the text editing area 1102, the first user account is unable to edit the added service state information 1110 in the text editing area 1102. If the first user account wants to modify the added service state information 1110 into expression state information, the control for enabling a synchronization state in FIG. 11 needs to be off so as to disable the synchronization function of service state information 1110. After the control 1107 for enabling a synchronization state is disabled, the service state information 1110 disappears automatically, and the first user account may customize the expression state information in the text editing area 1102.

In the embodiment of the disclosure, by adding the service state information 1110 to the header of the state editing information 1103, not only it may be realized that the service state information 1110 is timely and synchronously displayed, but also the service state information 1110 may be displayed in front of the text state information 11031, so that the service state information 1110 is visually and clearly displayed to the first user account and/or other user accounts that have a social relationship with the first user account, the convenience to obtain service state information 1110 by the first user account and/or other user accounts is improved, and the user experience of the first user account and/or other user accounts is thus improved.

FIG. 12 illustrates a flowchart of displaying state recommendation information according to an embodiment. As shown in FIG. 12, in an embodiment, the state editing page further includes a selection area of state recommendation information, and the method may further include the steps at S51-S53.

At S51, state recommendation information corresponding to the first user account is received in the selection area of state recommendation information.

At S53, the state recommendation information is displayed on the first page.

In an example, the first user account may trigger a selection instruction by selecting the state recommendation information in the selection area of state recommendation information. The first terminal responds to the selection instruction and receives the state recommendation information corresponding to the first user account in the selection area of state recommendation information

In an example, the state recommendation information may be information that is preset in the selection area of state recommendation information without user-defined editing.

In an example, the state recommendation information may include, but is not limited to, text, pictures, videos, and the like.

In an example, the selection area of state recommendation information may be located anywhere on the state editing page. In an example, as shown in FIG. 6, the selection area 608 of state recommendation information 609 in FIG. 6 may be located below the text editing area 602, and the state recommendation information 609 may be a picture.

In an embodiment of the disclosure, when the first user account selects the state recommendation information in the selection area of state recommendation information, a selection instruction is triggered. The first terminal responds to the selection instruction, receives the state recommendation information, and displays the state recommendation information on the first page, thus further enriching the expression form of state information of the first user account, being helpful for the first user account and/or other user accounts to obtain various types of personal state information of the first user account in time, and improving the richness of displaying state information and user experience.

In an optional embodiment, the above method may also include: in response that the service event is monitored, obtaining start time and end time corresponding to the service state information; and displaying the start time and the end time on the first page.

Specifically, the start time refers to a start moment when the first user account is in the service state information (for example, a business trip state, a vacation state, a meeting state, etc.), and the end time refers to an end moment when the first user account ends the service state information. For example, when the first user account goes on business trip from December 12th to December 20th, the start time of the business trip state of the first user account is December 12th, and the end time is December 20th.

In an example, when the first terminal monitors a service event, the start time and end time corresponding to the service state information may be obtained from the calendar.

In an example, if the current time when the service event is first monitored is earlier than the start time, the first terminal may directly display the service state information corresponding to the service event at the current time without, the start time and the end time waiting for the start time. In some embodiments, the first terminal may also display the service state information, the start time and the end time on the first page when the current time reaches the start time.

In an embodiment, when the current time is later than the end time, the first terminal may automatically cancel the display of the service state information, the corresponding start time and end time.

In another embodiment, if the current time has not yet reached the end time, the first user account closes the control 607 for enabling a synchronization state in the state editing page 601 as shown in FIG. 6, which means that the first user account actively cancels simultaneous display function of service state information 610. In this case, even if the current time has not reached the end time, the first terminal may cancel the display of the service state information 610, the start time and the end time.

In this embodiment of the disclosure, when the first terminal monitors the service events, the start time and end time corresponding to the service state information are obtained and sent to the second terminal for display, which further enriches the expression form of state information of the first user account, the display of the start time and end time may facilitate the first user account to know the start and end time of its own service state information, and may also be convenient for other user accounts having a relationship with the first user account to manage communication expectations with the first user account (i.e., other user accounts may reasonably arrange the communication time with the first user account through the start time and end time), improving communication efficiency and user experience.

In an embodiment, the first page includes a personal homepage of the first user account, the personal homepage displays image information of the first user account. Displaying service state information corresponding to the service event in the first preset area of the first page of the first terminal may include: displaying the service state information in a third preset area where the image information is located.

In an example, the third preset area includes but is not limited to a lower area, left and right areas, an upper area and the like where the image information is located.

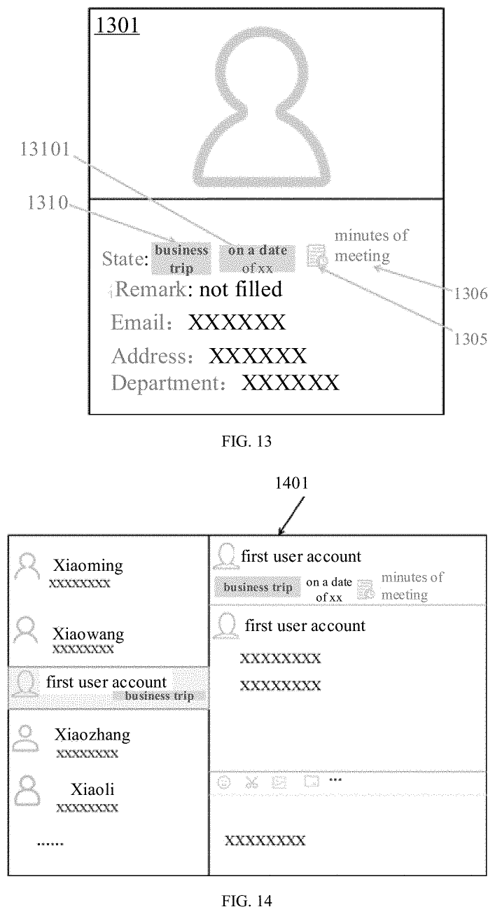

FIG. 13 illustrates a schematic diagram of another personal homepage 1301 for a user account according to an embodiment. As shown in FIG. 13, after a personal state of the first user account takes effect, the service state information 1310 may be displayed in a third preset area where image information in the personal homepage 1301 of the first user account is located.

In an example, in addition to displaying the service state information 1310 on the personal homepage 1301 of the user account, all personal state information of the first user account may also be displayed on the personal homepage 1301, and the all personal state information may include but not be limited to at least one of, service state information, state editing information (including text state information, expression state information), parse information (e.g., an icon 1305 and a keyword 1306), and the like.

In an example, the start time 13101 and end time of the service state information may also be displayed on a user account personal homepage 1301 in a second application.

In an embodiment of the disclosure, by displaying the service state information on the user account personal homepage, not only it may be realized that the service state information is timely and synchronously displayed, but also the service state information may be displayed in different positions, so as to realize the diversification of multiple display positions of the service state information. This increases the exposure of the service state information, which is convenient for the first user account and/or other user accounts that have a social relationship with the first user account to obtain the service state information.

In an embodiment, the first page includes account identifier information of the first user account, and the first page is at least one of: a user account list page and a session page corresponding to the first user account, a user account prompt page in an information interaction group, a user account selection page and a user account search page. The information interaction group is an interaction group including the first user account. Displaying the service state information corresponding to the service event in the first preset area of the first page of the first terminal may include: displaying the service state information in a fourth preset area where the account identifier information is located.

FIG. 14 illustrates a schematic diagram of a session page 1401 according to an embodiment. As shown in FIG. 14, after a personal state of the first user account takes effect, the service state information of the first user account may be displayed in a fourth preset area where an account identifier information in the session page is located.

In an example, the fourth preset area may be a surrounding area of the identifier information, for example, a lower area, a rear area, etc. of the account identifier information.

In an example, all personal state information of the first user account may also be displayed on the session page, and all the personal state information may include but not limited to, service state information, state editing information (including text state information, expression state information), parse information, etc.

In an example, the start time and end time of the service state information may also be displayed on the session page.

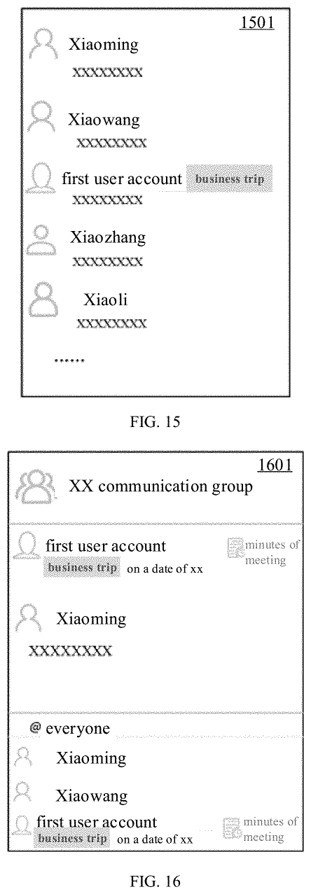

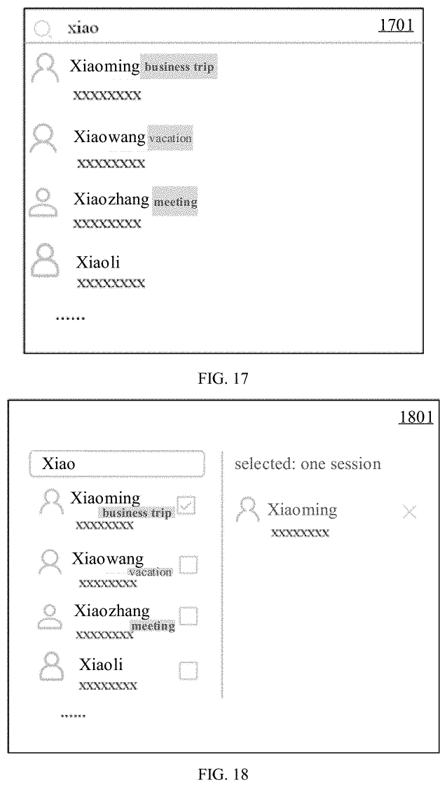

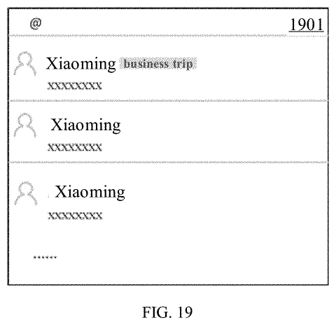

FIG. 15 illustrates a schematic diagram of a user account list page 1501 according to an embodiment. FIG. 16 illustrates a schematic diagram of a user account prompt page 1601 in an information interaction group according to an embodiment. FIG. 17 illustrates a schematic diagram of a user account search page 1701 according to an embodiment. FIG. 18 illustrates a schematic diagram of a user account selection page 1801 according to an embodiment. FIG. 19 illustrates a schematic diagram of a message aggregator 1901 according to an embodiment. In an example, after the personal state of the first user account takes effect, the service state information is displayed in the user account list page 1501 (roomlist) of FIG. 15, in the user account prompt page 1601 (@list) in the information interaction group of FIG. 16, in the user account search page 1701 of FIG. 17, in the user account selection page 1801 (a component for selecting a user account) of FIG. 18, in a message aggregator 1901 of FIG. 19 and the like.

The message aggregator 1901 refers to a message aggregation container with special types, such as urgent, @my, and special attention.

In an example, the information interaction group may be an interaction group formed by the first user account and other user accounts having social relationships, for example, a communication group in instant messaging software.

In an example, the start time and end time corresponding to the service state information may also be displayed in the user account list page (roomlist), in the user account prompt page 1601 (@list) in the information interaction group, in the user account search page 1701, in the user account selection page 1801 (a component for selecting a user account), in the message aggregator 1901, etc.

In an example, for the user account list page 1501, the user account prompt page 1601, the user account search page 1701, the user account selection page 1801 and the message aggregator 1901, the fourth preset area 1403 may be the rear area where the account identifier information is located.

In an embodiment of the disclosure, by displaying the service state information in at least one of the user account list page 1501, the session page, the user account prompt page 1601 in the information interaction group, the user account selection page 1801, and the user account search page 1701, not only it may be realized that the service state information may be timely and synchronously displayed, but also the service state information may be also displayed in different positions, so as to realize the diversification of display positions of service state information. This increases the exposure of service state information, which is convenient for the first user account and/or other user accounts that have a social relationship with the first user account to obtain the service state information from various channels, and improves user experience.

In an embodiment, the method may further include:

in response to a first operation instruction, obtaining a duration corresponding to the service state information, in which the first operation instruction is triggered by the first user account based on the service state information displayed in the first preset area, and the duration represents a time difference between end time corresponding to the service state information and current time; and displaying the duration in a second preset area where the service state information is located.

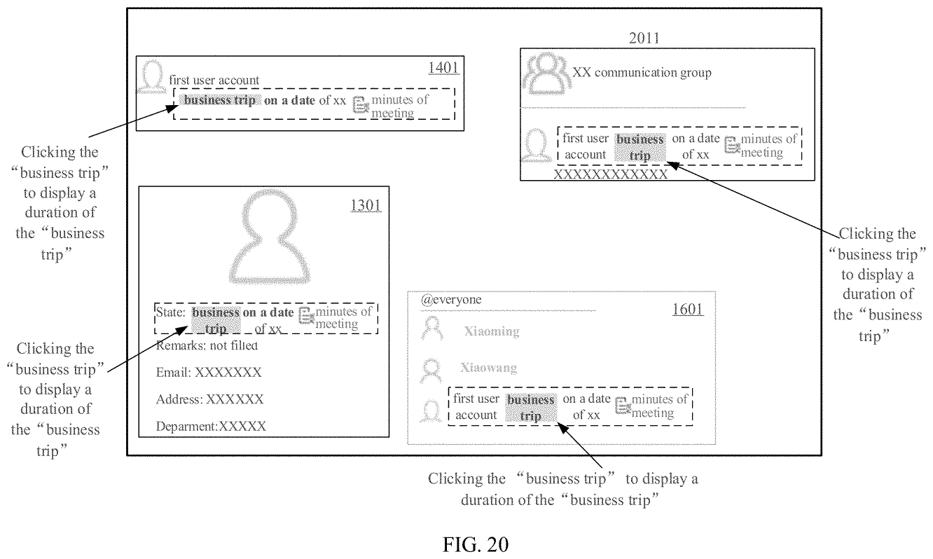

FIG. 20 illustrates a schematic diagram of clicking service state information and displaying duration according to an embodiment. As shown in FIG. 20, the first user account may trigger a first operation instruction by operating the service state information displayed in a user account personal homepage 1301, a session page 1401, an information interaction page 2101 in an information interaction group 2011, a user account list page 1501, a prompt page 1601 in the information interaction group 2011, a user account search page 1701, a user account selection page 1801 and other pages. The first terminal responds to the first operation instruction and determines a difference value between end time of the service state information and current time as a duration corresponding to the service state information, and displays the service state information in a second preset area where the service state information is located.

In an example, the operations of the service state information may include, but are not limited to, a click operation, a long-press operation, a hover operation, and the like.

Taking the hovering operation as an example, the display duration is explained. The first user account may trigger the first operation instruction by hovering an operation tool (for example, a mouse) on the service state information for a preset time (for example, 3 s). In response to the first operation instruction, the first terminal displays the duration in the second preset area where the service state information is located.

In an example, the second preset area may be a surrounding area of the service state information, for example, an upper area, a lower area, left and right areas, etc. of the service state information.

In the embodiment of the disclosure, in response to an operation instruction triggered by the first user account based on the service state information, the duration is displayed in the second preset area where the service state information is located. This further enriches the expression form of the state information of the first user account, and is convenient for the first user account to know the duration of its own service state, so as to effectively manage its own business progress and improve the experience. This may also facilitate other user accounts that have social relations with the first user account to manage the communication expectations with the first user account (i.e., other user accounts may reasonably arrange the communication time with the first user account through this duration), so as to improve communication efficiency and user experience.

In an embodiment, the method may further include: sending the service state information and other state information to a second terminal, in which the other state information includes at least one of the parse information, the state editing information and the state recommendation information, the second terminal is configured to display the service state information on a second page, and/or to display the service state information and the other state information on a third page; a second user account corresponding to the second terminal and the first user account have a social relationship.

The second page includes at least one of a user account list page, a user account prompt page in an information interaction group, a user account search page and a user account selection page. The information interaction group is an interaction group to which the first user account and the second user account belong;

The third page includes at least one of: a user account personal homepage, a first information interaction page, and a second information interaction page. The first information interaction page is a page where the first user account performs information interaction with the second user account. The second information interaction page is a page in the information interaction group.

In an example, the first terminal may send the service state information and other state information to a server, and the server forwards the service state information and other state information to a second terminal.

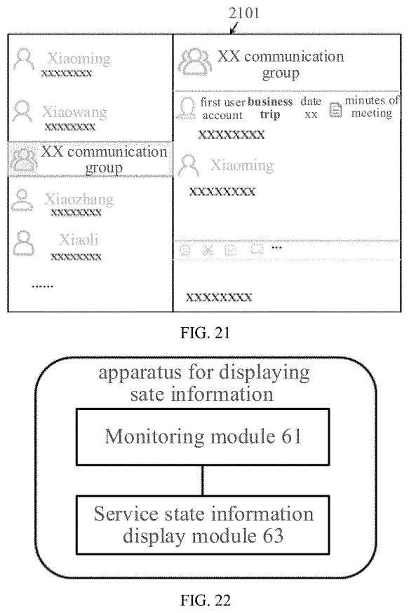

FIG. 21 illustrates a schematic diagram of a second information interaction page 2101 according to an embodiment. As shown in FIG. 21, after the personal state of the first user account takes effect, all personal state information of the first user account may be displayed to a second user account, at a rear area of identifier information of the first user account on the second information interaction page 2101 of the second terminal. All the personal state information may include but not limited to, service state information, state editing information, parse information, etc.

It should be noted that, diagrams of the user account list page, the user account prompt page in the information interaction group, the user account search page, the user account selection page, the user account personal homepage, etc., and locations of service state information displayed in the diagrams and other state information are similar to those of the first user account, which are not repeated here.

Specifically, after the service state information and other state information are received, the second terminal may display the service state information on the second page, and/or display the service state information and the other state information on the third page. On one hand, it is achieved that the service state information (such as leaves, meetings, business trips, etc.) is displayed synchronously to the second user account with social relationship, and the timeliness of obtaining service state information is improved. On the other hand, the second user account does not need to know service state information (such as leaves, meetings, and business trips) of the first user account through other channels, the consumption of system resources is reduced in the process of acquiring service state information. On the other hand, since the second terminal may display service state information and/or other state information on different pages, the expression form of the state information of the first user account is enriched, which is helpful for the second user account to obtain various types of state information of the first user account in time, and the richness of displaying state information and user experience are improved. On the one hand, since the second page includes at least one of the user account list page, the user account prompt page in the information interaction group, the user account search page, and the user account selection page, and the third page includes at least one of the user account personal homepage, the first information interaction the page and the second information interaction page, the service state information may be displayed in different positions, the diversification of the display positions of the service state information is realized and the exposure of the service state information is thus increased, so that the second user account may obtain the service state information from a variety of channels, further improving the user experience.

In an optional embodiment, the second terminal is configured to obtain a duration corresponding to the service state information in response to a second operation instruction, and to display the duration in a fifth preset area where the service state information is located.

The second operation instruction is triggered by the second user account based on the service state information displayed on the second page and/or the third page, and the duration represents a time difference between end time corresponding to the service state information and current time.

In an example, the second user account may trigger a second operation instruction by operating the service state information displayed on the second terminal. The second terminal responds to the second operation instruction and determines a difference value between the end time of the service state information and the current time as the duration corresponding to the service state information, and the duration is displayed in the fifth preset area where the service state information is located.

In an example, the operations on the service state information may include, but are not limited to, a click operation, a long-press operation, a hover operation, and the like.

In an example, the fifth preset area may be a surrounding area of the service state information, for example, an upper area, a lower area, left and right areas, etc. of the service state information.

In the embodiment of the disclosure, in response to the operation instruction triggered by the second user account based on the service state information, the duration is displayed in the fifth preset area where the service state information is located, so that the expression form of the object state may be further enriched, it is convenient for the second user account to manage the communication expectations with the first user account (i.e., the second user account may reasonably arrange the communication time with the first user account through the duration displayed by the second terminal, communication efficiency and user experience are improved.

In an operable embodiment, the first terminal may also send the start time and end time corresponding to the service state information to the second terminal, and the second terminal may display them on the corresponding page, which may be convenient for the second user account to manage communication expectations with the first user account (i.e., the second user account may reasonably arrange the communication time with the first user account through the start time and end time displayed on the second terminal, thus improving communication efficiency and user experience.

FIG. 22 illustrates a block diagram of an apparatus for displaying state information according to an embodiment. Referring to FIG. 22, the apparatus is applied to a first terminal logged with a first user account. The apparatus may include a monitoring module 61 and a service state information display module 63.

The monitoring module 61 is configured to monitor a service event in a target application associated with the first user account

The service state information display module 63 is configured to in response that the service event is monitored, display service state information corresponding to the service event in a first preset area of a first page of the first terminal.

In an embodiment, the service event includes at least one of: a business trip approval event, a vacation approval event and an event for initiating or accepting a meeting schedule, and the service state information includes at least one of: a business trip state corresponding to the business trip approval event, a vacation state corresponding to the vacation approval event, and a meeting state corresponding to the event for initiating or accepting a meeting schedule.

The service state information display module 63 includes: a first display unit, configured to display the business trip state in the first preset area in response that the business trip approval event is monitored; and/or a second display unit, configured to display the vacation state in the first preset area in response that the vacation approval event is monitored; and/or a third display unit, configured to display the meeting state in the first preset area in response that the event for initiating or accepting a meeting schedule is monitored.

In an embodiment, in response that the event for initiating or accepting a meeting schedule is monitored, the apparatus further includes: a display continuing module, configured to in response that the business trip state and/or the vacation state is displayed in the first preset area, continue to display the business trip state and/or the vacation state in the first preset area; and a meeting state display module, configured to in response that the business trip state and/or the vacation state is not displayed in the first preset area, display the meeting state in the first preset area.

In an embodiment, the third display unit includes: a service state display sub-unit, configured to in response to the meeting schedule event being a preset schedule event, display service state information corresponding to the preset schedule event in the first preset area; and a meeting state display sub-unit, configured to in response to the meeting schedule event being an event other than the preset schedule event, display the meeting state in the first preset area.

In an embodiment, the apparatus further includes: a state editing page display module, configured to display a state editing page, in which the state editing page includes a text editing area; an information resource link receiving module, configured to receive an information resource link in the text editing area; a first parse information display module, configured to display parse information corresponding to the information resource link in the text editing area, in which the parse information includes an icon and a keyword, the icon corresponds to a type of information resource represented by the information resource link, and the key word is a keyword of the information resource; and a second parse information display module, configured to display the parse information on the first page.

In an embodiment, the apparatus further includes: a state editing information receiving module, configured to receive state editing information corresponding to the first user account in the text editing area, in which the state editing information includes text state information and/or expression state information; and a state editing information display module, configured to display the state editing information on the first page.

In an embodiment, the apparatus further includes: a state information updating module, configured to in response to the expression state information being included in the state editing information, obtain updated state information by updating the expression state information in the state editing information in the text editing area based on the service state information; and a updated state display module, configured to display the updated state information on the first page.

In an embodiment, the apparatus further includes: an addition module, configured to in response to the expression state information being not included in the state editing information, obtain added state information by adding the service state information to a header of the state editing information in the text editing area; and an added state display module, configured to display the added state information on the first page.

In an embodiment, the state editing page further includes a selection area of state recommendation information, and the apparatus further includes: a state recommendation information receiving module, configured to receive state recommendation information corresponding to the first user account in the selection area of state recommendation information; and a state recommendation information display module, configured to display the state recommendation information on the first page.

In an embodiment, the monitoring module is configured to in response to a service state synchronization instruction, monitor the service event, in which the service state synchronization instruction is triggered by the first user account based on the state editing page.

In an embodiment, the apparatus further includes: a duration obtaining module, configured to in response to a first operation instruction, obtain a duration corresponding to the service state information, in which the first operation instruction is triggered by the first user account based on the service state information displayed in the first preset area, and the duration represents a time difference between end time corresponding to the service state information and current time; and a duration display module, configured to display the duration in a second preset area where the service state information is located.

In an embodiment, the apparatus further includes: a start and end time obtaining module, configured to in response that the service event is monitored, obtaining start time and end time corresponding to the service state information; and a start and end time display module, configured to displaying the start time and the end time on the first page.

In an embodiment, the first page includes a personal homepage of the first user account, and image information of the first user account is displayed on the personal homepage; the service state information display module is configured to: display the service state information in a third preset area where the image information is located.

In an embodiment, the first page includes account identifier information of the first user account, the first page is at least one of: a user account list page and a session page corresponding to the first user account, a user account prompt page in an information interaction group, a user account selection page and a user account search page; the information interaction group is an interaction group including the first user account; the service state information display module is configured to: display the service state information in a fourth preset area where the account identifier information is located.

In an embodiment, the apparatus further includes: a sending module, configured to send the service state information and other state information to a second terminal, in which the other state information includes at least one of the parse information, the state editing information and the state recommendation information, the second terminal is configured to display the service state information on a second page, and/or to display the service state information and the other state information on a third page; a second user account corresponding to the second terminal and the first user account have a social relationship.

The second page includes at least one of a user account list page, a user account prompt page in an information interaction group, a user account search page and a user account selection page; the information interaction group is an interaction group to which the first user account and the second user account belong.

The third page includes at least one of: a user account personal homepage, a first information interaction page, and a second information interaction page; the first information interaction page is a page where the first user account performs information interaction with the second user account. The second information interaction page is a page in the information interaction group.

In an embodiment, the second terminal is configured to obtain a duration corresponding to the service state information in response to a second operation instruction, and to display the duration in a fifth preset area where the service state information is located;

The second operation instruction is triggered by the second user account based on the service state information displayed on the second page and/or the third page, and the duration represents a time difference between end time corresponding to the service state information and current time.

Regarding the apparatus in the embodiment, the specific manner in which each module performs operations has been described in detail in the embodiment of the method, and may not be described in detail here.

In an embodiment, an electronic device is also provided, which includes a processor and a memory for storing instructions executable by the processor. When the processor is configured to execute the instructions stored in the memory, the steps of any of the methods for displaying state information in the above embodiments are implemented.

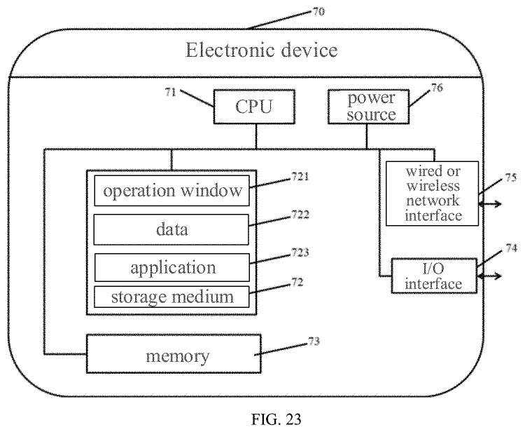

The electronic device may be a terminal, a server, or a similar computing device. Taking the electronic device being a server as an example. FIG. 23 illustrates a block diagram of an electronic device for displaying state information according to an embodiment. The electronic device 70 may vary greatly due to different configurations or performances, and may include one or more central processing units (CPU) 71 (which may include, but is not limited to, a microprocessor MCU or a programmable logic device FPGA, and other processing apparatuses), a memory 73 for storing data, one or more storage medium 72 (e.g., one or more mass storage devices) storing application programs 723 or data 722. The memory 73 and the storage medium 72 may be short-term storage or persistent storage. The programs stored in the storage medium 72 may include one or more modules, and each module may include a series of instructions to operate on the electronic device. Furthermore, the central processing unit 71 may be configured to communicate with the storage medium 72 to execute a series of instruction operations in the storage medium 72 on the electronic device 70. The electronic device 70 may also include one or more power supplies 76, one or more wired or wireless network interfaces 75, one or more input and output interfaces (I/O interfaces) 74, and/or, one or more operating systems 721, such as Windows Server™, Mac OS X™, Unix™, Linux™, FreeBSD™ and the like.

The input/output interface 74 may be used to receive or transmit data via a network. The specific example of the network may include a wireless network provided by the communication provider of the electronic device 70. In an example, the I/O interface 74 includes a network interface controller (NIC), which may be connected to other network devices through the base station so as to communicate with the Internet. In an embodiment, the I/O interface 74 may be a radio frequency (RF) module, which is used to communicate with the Internet in a wireless manner.

Those skilled in the art may understand that the structure shown in FIG. 23 is exemplary, and does not limit the structure of the above electronic device. For example, the electronic device 70 may also include more or fewer components than shown in FIG. 23, or have a different configuration than that shown in FIG. 23.

In an embodiment, a computer-readable storage medium is also provided. When the instructions in the computer-readable storage medium are executed by a processor of an electronic device, the electronic device is enabled to perform the steps of any method for displaying state information in the embodiments.

In an embodiment, a computer program product is also provided, which includes a computer program. When the computer program is executed by a processor, the method for displaying state information in any one of the embodiments is implemented.

Those skilled in the art may understand that all or part of the processes in the methods of the above embodiments may be implemented by instructing relevant hardware through a computer program, and the computer program may be stored in a non-volatile computer-readable storage medium. When the computer program is executed, it may include the processes of the method embodiments. Any reference to memory, storage, database, or other medium used in the various embodiments of the disclosure may include non-volatile and/or volatile memory. The non-volatile memory may include a read only memory (ROM), a programmable ROM (PROM), an electrically programmable ROM (EPROM), an electrically erasable programmable ROM (EEPROM), or a flash memory. The volatile memory may include a random access memory (RAM) or an external cache memory. For illustration and not limitation, RAM is available in various forms, such as a static RAM (SRAM), a dynamic RAM (DRAM), a synchronous DRAM (SDRAM), a double data rate SDRAM (DDRSDRAM), an enhanced SDRAM (ESDRAM), a synchronous link (Synchlink) DRAM (SLDRAM), a memory bus (Rambus) direct RAM (RDRAM), a direct memory bus dynamic RAM (DRDRAM), and a memory bus dynamic RAM (RDRAM), etc.

Those skilled in the art will easily think of other embodiments of the disclosure after considering the description and practicing the invention disclosed herein. The disclosure is intended to cover any variations, uses, or adaptive changes of the present invention which follow the general principles of the present disclosure and include common knowledge or conventional technical means in the art not disclosed in the disclosure. The description and the embodiments are to be regarded as exemplary, and the true scope of the disclosure are indicated in the following claims.

It should be understood that the present invention is not limited to the precise structure described above and illustrated in the drawings. The scope of the present disclosure is limited by the appended claims.

What is claimed is:

1. A method for displaying state information, performed by a first terminal logged with a first user account, the method comprising:
monitoring a service event in a target application associated with the first user account; and
in response that the service event is monitored, displaying service state information corresponding to the service event in a first preset area of a first page of the first terminal.

2. The method of claim 1, wherein the service event comprises at least one of: a business trip approval event, a vacation approval event and an event for initiating or accepting a meeting schedule, and the service state information comprises at least one of: a business trip state corresponding to the business trip approval event, a vacation state corresponding to the vacation approval event, and a meeting state corresponding to the event for initiating or accepting a meeting schedule;
in response that the service event is monitored, displaying service state information corresponding to the service event in a first preset area of a first page of the first terminal comprises at least one of:
in response that the business trip approval event is monitored, displaying the business trip state in the first preset area;
in response that the a vacation approval event is monitored, displaying the vacation state in the first preset area; and
in response that the event for initiating or accepting a meeting schedule is monitored, displaying the meeting state in the first preset area.

3. The method of claim 2, wherein in response that the event for initiating or accepting a meeting schedule is monitored, the method further comprises:
in response that at least one of the business trip state and the vacation state is displayed in the first preset area, continuing to display at least one of the business trip state and the vacation state in the first preset area; and
in response that at least one of the business trip state and the vacation state is not displayed in the first preset area, displaying the meeting state in the first preset area.

4. The method of claim 2, wherein in response that the event for initiating or accepting a meeting schedule is monitored, displaying the meeting state in the first preset area comprises:
in response to the meeting schedule event being a preset schedule event, displaying service state information corresponding to the preset schedule event in the first preset area; and
in response to the meeting schedule event being an event other than the preset schedule event, displaying the meeting state in the first preset area.

5. The method of claim 1, further comprising:
displaying a state editing page, wherein the state editing page comprises a text editing area;
receiving an information resource link in the text editing area;
displaying parse information corresponding to the information resource link in the text editing area, wherein the parse information comprises an icon indicating a type of information resource and a keyword of the information resource; and
displaying the parse information on the first page.

6. The method of claim 5, further comprising:
receiving state editing information corresponding to the first user account in the text editing area, wherein the state editing information comprises at least one of text state information and expression state information; and
displaying the state editing information on the first page.

7. The method of claim 6, further comprising at least one of:
in response to the expression state information being included in the state editing information, obtaining updated state information by updating the expression state information in the text editing area based on the service state information; and displaying the updated state information on the first page; and
in response to the expression state information being not included in the state editing information, obtaining added state information by adding the service state information at the beginning of the state editing information in the text editing area; and displaying the added state information on the first page.

8. The method of claim 6, wherein the state editing page further comprises a selection area of state recommendation information, and the method further comprises:
receiving state recommendation information corresponding to the first user account in the selection area; and
displaying the state recommendation information on the first page.

9. The method of claim 5, wherein monitoring the service event associated with the first user account in the target application comprises:
in response to a service state synchronization instruction, monitoring the service event, wherein the service state synchronization instruction is triggered by an operation of the first user account on the state editing page.

10. The method of claim 1, further comprising:
in response to a first operation instruction, obtaining a duration corresponding to the service state information, wherein the first operation instruction is triggered by an operation of the first user account on the service state information, and the duration represents a time difference between end time corresponding to the service state information and current time; and
displaying the duration in a second preset area where the service state information is located.

11. The method of claim 1, further comprising:
in response that the service event is monitored, obtaining start time and end time corresponding to the service state information; and
displaying the start time and the end time on the first page.

12. The method of claim 1, wherein the first page comprises a personal homepage of the first user account, and image information of the first user account is displayed on the personal homepage; displaying service state information corresponding to the service event comprises:
displaying the service state information in a third preset area where the image information is located.

13. The method of claim 1, wherein the first page comprises account identifier information of the first user account, the first page is at least one of: a user account list page and a session page corresponding to the first user account, a user account prompt page in an information interaction group, a user account selection page and a user account search page; the information interaction group comprises the first user account; displaying the service state information corresponding to the service event comprises:
displaying the service state information in a fourth preset area where the account identifier information is located.

14. The method of claim 8, further comprising:
sending the service state information and other state information to a second terminal, wherein the other state information comprises at least one of the parse information, the state editing information and the state recommendation information, the second terminal is configured to perform at least one of displaying the service state information on a second page, and displaying the service state information and the other state information on a third page; a second user account corresponding to the second terminal and the first user account have a social relationship;
wherein the second page includes at least one of a user account list page, a user account prompt page in an information interaction group, a user account search page and a user account selection page; the information interaction group comprises the first user account and the second user account;
the third page comprises at least one of: a user account personal homepage, a first information interaction page, and a second information interaction page; the first information interaction page is a page where the first user account performs information interaction with the second user account; the second information interaction page is a page in the information interaction group.

15. The method of claim 14, wherein:
the second terminal is configured to obtain a duration corresponding to the service state information in response to a second operation instruction, and to display the duration in a fifth preset area where the service state information is located;
the second operation instruction is triggered by an operation of the second user account on the service state information, and the duration represents a time difference between end time corresponding to the service state information and current time.

16. An electronic device, comprising:
a processor; and
a memory for storing instructions executable by the processor;
wherein the processor is configured to:
monitor a service event in a target application associated with the first user account; and
in response that the service event is monitored, display service state information corresponding to the service event in a first preset area of a first page of the first terminal.

17. The electronic device of claim 16, wherein the service event comprises at least one of: a business trip approval event, a vacation approval event and an event for initiating or accepting a meeting schedule, and the service state information comprises at least one of: a business trip state corresponding to the business trip approval event, a vacation state corresponding to the vacation approval event, and a meeting state corresponding to the event for initiating or accepting a meeting schedule;
wherein the processor is further configured to perform at least one of:
in response that the business trip approval event is monitored, displaying the business trip state in the first preset area;
in response that the vacation approval event is monitored, displaying the vacation state in the first preset area; and
in response that the event for initiating or accepting a meeting schedule is monitored, displaying the meeting state in the first preset area.

18. The electronic device of claim 17, wherein the processor is further configured to:
in response that at least one of the business trip state and the vacation state is displayed in the first preset area, continue to display at least one of the business trip state and the vacation state in the first preset area; and
in response that at least one of the business trip state and the vacation state is not displayed in the first preset area, display the meeting state in the first preset area.

19. The electronic device of claim 16, wherein the processor is further configured to:
in response to the meeting schedule event being a preset schedule event, display service state information corresponding to the preset schedule event in the first preset area; and
in response to the meeting schedule event being an event other than the preset schedule event, display the meeting state in the first preset area.

20. A non-transitory computer readable storage medium, when instructions in the computer readable storage medium are executed by a processor of an electronic device, the electronic device is caused to execute a method for displaying state information, the method comprising:
monitoring a service event in a target application associated with the first user account; and
in response that the service event is monitored, displaying service state information corresponding to the service event in a first preset area of a first page of the first terminal.
